(19) United States
(12) Patent Application Publication
(10) Pub. No.: US 2026/0127720 A1
(43) Pub. Date: May 7, 2026

(54) MACHINE LEARNING-BASED VIDEO DENOISING WITH ADAPTIVE FUSION

(71) Applicant: Samsung Electronics Co., Ltd., Suwon-si (KR)

(72) Inventors: Hakan Emre Gedik, Austin, TX (US); Zhiyuan Mao, Frisco, TX (US); John W. Glotzbach, Allen, TX (US); John Seokjun Lee, Allen, TX (US); Hamid R. Sheikh, Allen, TX (US)

(21) Appl. No.: 18/939,208

(22) Filed: Nov. 6, 2024

(51) Int. Cl. G06T 5/70; G06V 10/75; G06V 10/80

(52) U.S. Cl. CPC G06T 5/70; G06V 10/75; G06V 10/806

(57) ABSTRACT

A method includes obtaining, using at least one processing device of an electronic device, a video having a sequence of image frames. During each of multiple iterations, the method also includes identifying, using the at least one processing device, features of a specified image frame in the sequence and features of a denoised version of a preceding image frame. During each of the multiple iterations, the method further includes aligning, using the at least one processing device, the features of the specified image frame in the sequence and the features of the denoised version of the preceding image frame to generate aligned features. In addition, during each of the multiple iterations, the method includes generating, using the at least one processing device, a denoised version of the specified image frame based on the aligned features.

### TECHNICAL FIELD

This disclosure relates generally to image processing. More specifically, this disclosure relates to machine learning-based video denoising with adaptive fusion.

### BACKGROUND

Many mobile electronic devices, such as smartphones and tablet computers, include digital cameras that can be used to capture still and video images. In some cases, raw image data captured using digital cameras typically undergoes various processing operations that may collectively be referred to as an image signal processing (ISP) pipeline, which generates final images that can be stored or displayed. One common operation in an ISP pipeline is denoising, which aims to reduce the severity of noise that is inherent in the imaging process or that is introduced during preceding processing operations in the ISP pipeline. The quality of the noise reduction directly impacts the perceptual quality of the resulting images.

### SUMMARY

This disclosure relates to machine learning-based video denoising with adaptive fusion.

In a first embodiment, a method includes obtaining, using at least one processing device of an electronic device, a video having a sequence of image frames. During each of multiple iterations, the method also includes identifying, using the at least one processing device, features of a specified image frame in the sequence and features of a denoised version of a preceding image frame. During each of the multiple iterations, the method further includes aligning, using the at least one processing device, the features of the specified image frame in the sequence and the features of the denoised version of the preceding image frame to generate aligned features. In addition, during each of the multiple iterations, the method includes generating, using the at least one processing device, a denoised version of the specified image frame based on the aligned features.

In a second embodiment, an apparatus includes at least one processing device configured to obtain a video having a sequence of image frames. The at least one processing device is also configured, during each of multiple iterations, to identify features of a specified image frame in the sequence and features of a denoised version of a preceding image frame, align the features of the specified image frame in the sequence and the features of the denoised version of the preceding image frame to generate aligned features, and generate a denoised version of the specified image frame based on the aligned features.

In a third embodiment, a non-transitory machine-readable medium contains instructions that when executed cause at least one processor to obtain a video having a sequence of image frames. The non-transitory machine-readable medium also contains instructions that when executed cause the at least one processor, during each of multiple iterations, to identify features of a specified image frame in the sequence and features of a denoised version of a preceding image frame, align the features of the specified image frame in the sequence and the features of the denoised version of the preceding image frame to generate aligned features, and generate a denoised version of the specified image frame based on the aligned features.

Any one or any combination of the following features may be used with the first, second, or third embodiment. An initial denoised image frame may be generated based on first and second image frames in the sequence. The iterations may be performed to denoise subsequent image frames in the sequence after the first and second image frames, and each subsequent image frame may be denoised using the denoised version of the preceding image frame. During each iteration, the features of the specified image frame in the sequence and the features of the denoised version of the preceding image frame may be aligned by down-sampling filtered versions of the specified image frame and the preceding image frame to generate down-sampled image frames, performing optical flow estimation based on the down-sampled image frames to generate an optical flow, up-sampling the optical flow to generate an up-sampled optical flow, and warping at least some of the features based on the up-sampled optical flow. During each iteration, the denoised version of the specified image frame may be generated by performing a fusion of the aligned features to generate fused features and performing decoding of the fused features to generate the denoised version of the specified image frame. During each iteration, the fusion of the aligned features may be performed by generating an attention map based on the aligned features using a trained machine learning model (where the attention map identifies how to fuse the aligned features) and performing a weighted combination of the features of the denoised version of the preceding image frame as aligned with the features of the specified image frame in the sequence. During each iteration, the fusion of the aligned features may be performed by embedding the aligned features in a first feature space using single-layer convolution, identifying pixel-wise correlations between the aligned features as embedded in the first feature space to generate a correlation map, embedding the correlation map in a second feature space, applying an activation function to the correlation map as embedded in the second feature space to generate an attention map (where the attention map identifies how to fuse the aligned features), and performing a weighted combination of the features of the denoised version of the preceding image frame as aligned with the features of the specified image frame in the sequence. Processing the specified image frames in conjunction with the denoised versions of the preceding image frames during the iterations may ensure temporal coherence in a denoised video sequence including the denoised versions of the image frames, thereby avoiding flickering in the denoised video sequence.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to. ” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. §112(f).

### BRIEF DESCRIPTION OF THE DRAWINGS

For a more complete understanding of this disclosure and its advantages, reference is now made to the following description taken in conjunction with the accompanying drawings:

FIG. 1 illustrates an example network configuration including an electronic device in accordance with this disclosure;

FIG. 2 illustrates an example architecture that supports machine learning-based video denoising with adaptive fusion in accordance with this disclosure;

FIGS. 3A and 3B illustrate an example feature extraction operation in the architecture of FIG. 2 in accordance with this disclosure;

FIGS. 4A and 4B illustrate another example feature extraction operation in the architecture of FIG. 2 in accordance with this disclosure;

FIG. 5 illustrates an example alignment operation in the architecture of FIG. 2 in accordance with this disclosure;

FIG. 6 illustrates an example fusion operation in the architecture of FIG. 2 in accordance with this disclosure;

FIG. 7 illustrates another example fusion operation in the architecture of FIG. 2 in accordance with this disclosure;

FIGS. 8A and 8B illustrate example results obtainable using machine learning-based video denoising with adaptive fusion in accordance with this disclosure; and

FIG. 9 illustrates an example method for machine learning-based video denoising with adaptive fusion in accordance with this disclosure.

### DETAILED DESCRIPTION

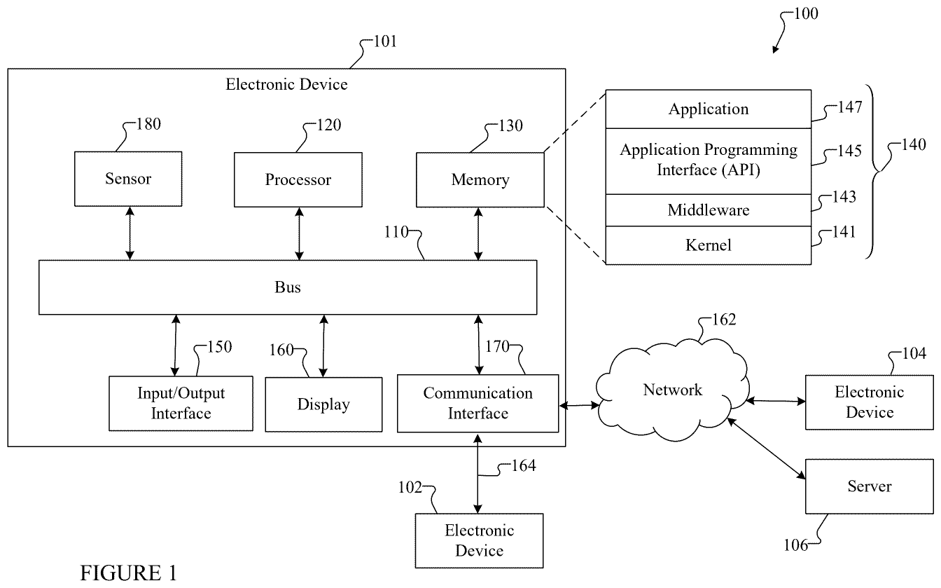

FIGS. 1 through 9, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure.

As noted above, many mobile electronic devices, such as smartphones and tablet computers, include digital cameras that can be used to capture still and video images. In some cases, raw image data captured using digital cameras typically undergoes various processing operations that may collectively be referred to as an image signal processing (ISP) pipeline, which generates final images that can be stored or displayed. One common operation in an ISP pipeline is denoising, which aims to reduce the severity of noise that is inherent in the imaging process or that is introduced during preceding processing operations in the ISP pipeline. The quality of the noise reduction directly impacts the perceptual quality of the resulting images. Traditional approaches for video denoising often rely on digital signal processing techniques. More recently, machine learning-based approaches for video denoising have been developed and have the potential to outperform the traditional approaches. These machine learning-based approaches typically leverage large amounts of data and iterative optimization techniques to learn noise patterns and removal techniques.

Unfortunately, machine learning-based approaches often require substantial amounts of memory to store multiple image frames, significant computational resources, and longer processing times to denoise image frames. This can make these approaches impractical for use in certain applications, such as with smartphones or other devices having limited resources where only a small number of image frames can be stored and processed at a time. Moreover, the statistical characteristics of noise tend to be highly dependent on the physical properties of the specific digital cameras and ISP pipelines being used. As a result, off-the-shelf machine learning-based approaches may produce images with lower perceptual quality, which may be due (among other reasons) to training data mismatches. In addition, machine learning-based approaches can often introduce temporal inconsistencies in denoised image frames, which can result in flickering artifacts or other artifacts in denoised video sequences, even when adequate denoising of individual image frames occurs.

This disclosure provides various techniques for machine learning-based video denoising with adaptive fusion. As described in more detail below, a video having a sequence of image frames can be obtained, such as by using one or more imaging sensors of an electronic device. During each of multiple iterations, features of a specified image frame in the sequence and features of a denoised version of a preceding image frame are identified, the features of the specified image frame in the sequence and the features of the denoised version of the preceding image frame are aligned to generate aligned features, and a denoised version of the specified image frame is generated based on the aligned features. In some cases, an initial denoised image frame may be generated based on first and second image frames in the sequence, and the iterations can be performed to denoise subsequent image frames in the sequence after the first and second image frames. Specific techniques for generating the features, aligning the features, and using the aligned features to create the denoised versions of the image frames are provided. By processing the specified image frames in conjunction with the denoised versions of the preceding image frames during the iterations, this may help to ensure temporal coherence in a denoised video sequence that includes the denoised versions of the image frames.

In this way, the described techniques can be used to implement video denoising more effectively in resource-constrained devices or other devices. For example, in some cases, the processing techniques used here may only involve the use of two image frames (such as a current image frame and a denoised version of the preceding image frame) during each image processing iteration. This can reduce computational and memory requirements and/or reduce processing times needed to denoise the image frames. Moreover, the described techniques are adaptive and can be applied to different applications and devices, including use with different imaging sensors and different image processing pipelines. In addition, achieving improved temporal coherence in a denoised video sequence can reduce or eliminate the creation of flickering artifacts or other artifacts in the denoised video sequence. Overall, these techniques can help to achieve better image quality in denoised video sequences, which can help to provide improved viewer satisfaction.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described below, the processor 120 may obtain and process video sequences and perform machine learning-based video denoising with adaptive fusion.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, obtain and process video sequences and perform machine learning-based video denoising with adaptive fusion. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the one or more sensors 180 can include one or more cameras or other imaging sensors, which may be used to capture images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that includes one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may obtain and process video sequences and perform machine learning-based video denoising with adaptive fusion.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

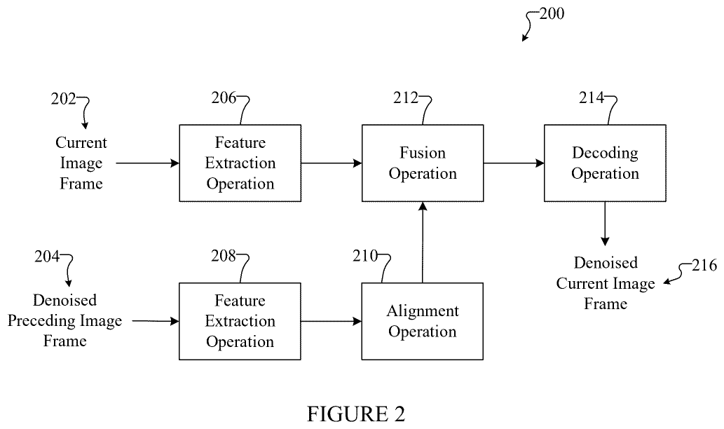

FIG. 2 illustrates an example architecture 200 that supports machine learning-based video denoising with adaptive fusion in accordance with this disclosure. For ease of explanation, the architecture 200 shown in FIG. 2 is described as being implemented on or supported by the electronic device 101 in the network configuration 100 of FIG. 1. However, the architecture 200 shown in FIG. 2 could be used with any other suitable device(s) and in any other suitable system(s), such as when the architecture 200 is implemented on or supported by the server 106.

As shown in FIG. 2, the architecture 200 generally operates to receive and process a current image frame 202 and a denoised preceding image frame 204. The current image frame 202 represents the image frame that is currently being denoised by the architecture 200. In some embodiments, the current image frame 202 may represent the most-recent video frame captured using at least one imaging sensor 180 of the electronic device 101. The denoised preceding image frame 204 represents a denoised or cleaner version of an image frame that precedes the current image frame 202 in a video sequence. As described below, the denoised preceding image frame 204 can be generated by the architecture 200 while processing the image frame that precedes the current image frame 202 in the video sequence.

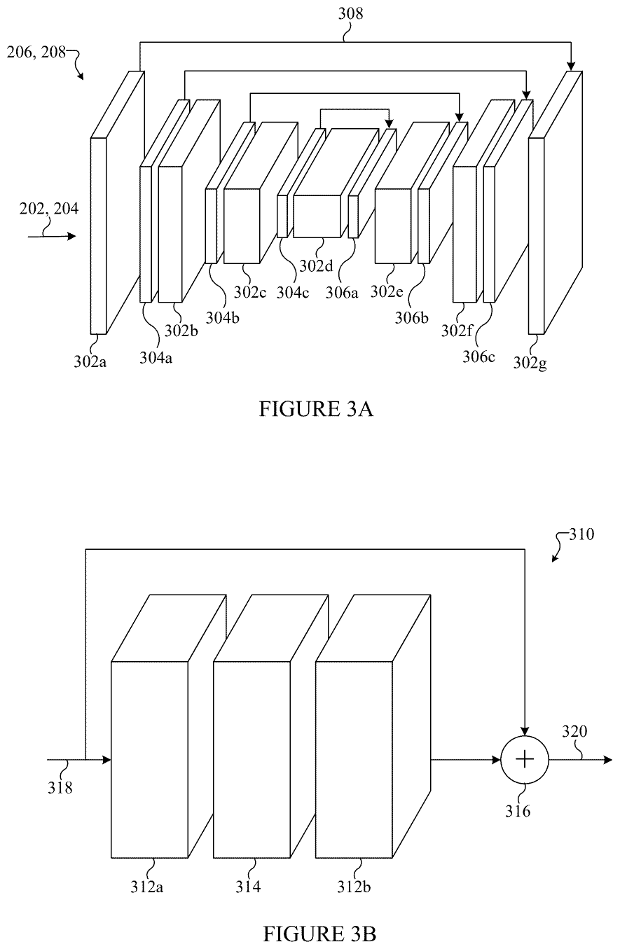

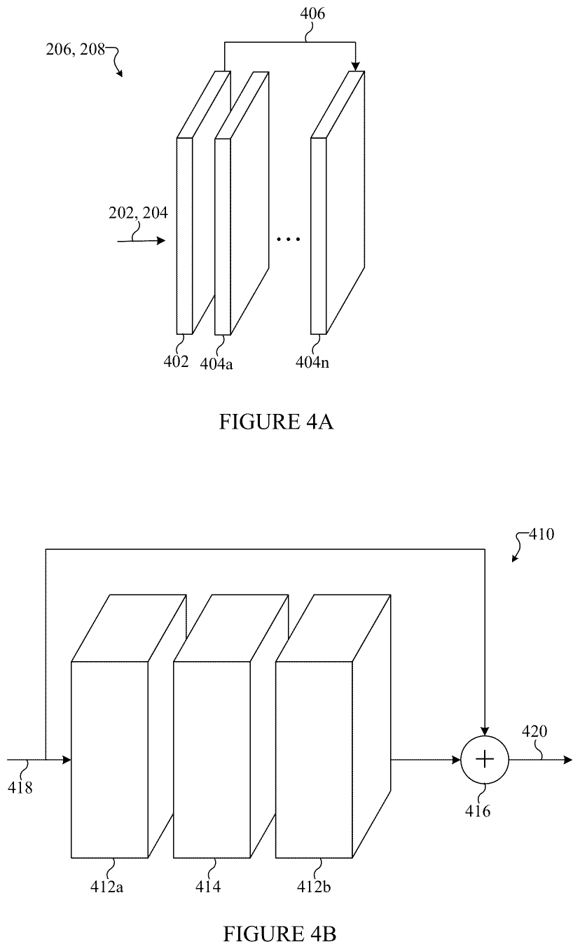

The current image frame 202 and the denoised preceding image frame 204 are processed using one or more feature extraction operations 206-208, which generally operate to identify features of the current image frame 202 and features of the denoised preceding image frame 204. Each feature extraction operation 206-208 may represent a trained machine learning model or other logic that is configured to extract relevant features of an image frame. In the context of FIG. 2, each feature extraction operation 206-208 may represent a trained machine learning model or other logic that is configured to extract features of an image frame that are relevant to an image denoising process. Each feature extraction operation 206-208 may be used to extract any suitable features from an image frame, and each feature extraction operation 206-208 may use any suitable technique(s) for extracting features of image frames. Example embodiments of the feature extraction operations 206-208 are shown in FIGS. 3A and 3B and in FIGS. 4A and 4B, which are described in more detail below. Note, however, that this disclosure is not limited to any particular technique(s) for performing feature extraction. Also note that while multiple feature extraction operations 206-208 are shown here, this is merely for ease of illustration, and the same feature extraction operation may be used to process the image frames 202, 204.

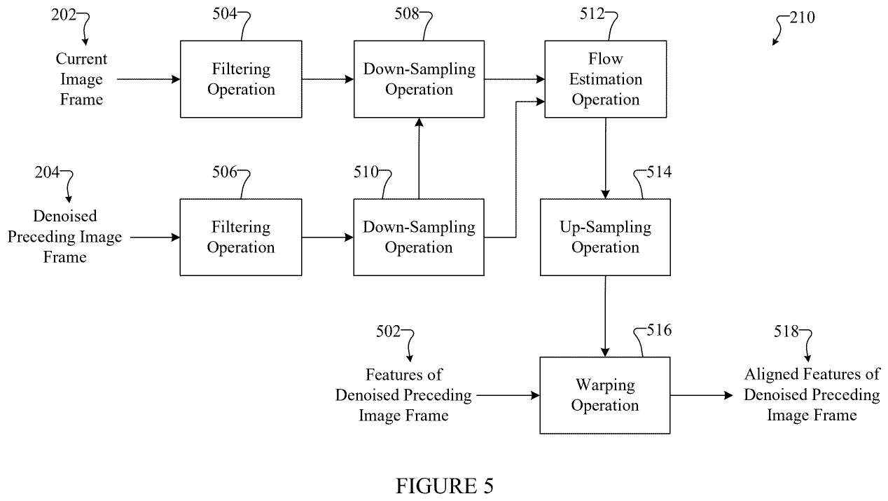

The extracted features of the denoised preceding image frame 204 are provided to an alignment operation 210, which generally operates to adjust those features in order to spatially align more closely with the extracted features of the current image frame 202. The alignment operation 210 may use any suitable technique(s) to align the extracted features. In some embodiments, for instance, the alignment operation 210 may process the image frames 202, 204 in order to identify an optical flow from the denoised preceding image frame 204 to the current image frame 202, and the alignment operation 210 can use the identified optical flow to warp the extracted features of the denoised preceding image frame 204. In some cases, the image frames 202, 204 may be down-sampled before the optical flow is identified, and the resulting optical flow vector(s) representing the identified optical flow may be up-sampled before the extracted features of the denoised preceding image frame 204 are warped. An example embodiment of the alignment operation 210 is shown in FIG. 5, which is described in more detail below. Note, however, that this disclosure is not limited to any particular technique(s) for performing feature alignment.

The extracted features of the current image frame 202 and the aligned extracted features of the denoised preceding image frame 204 are provided to a fusion operation 212, which generally operates to combine the extracted features in order to produce weighted or other fused features. The fusion operation 212 may represent a trained machine learning model or other logic that is configured to fuse the extracted features of the image frames 202, 204, such as by generating a weighted combination of the extracted features. For example, the fusion operation 212 may process the extracted features in order to generate an attention map, which can identify how to weight at least some of the extracted/aligned features. In some cases, the attention map can be used to make a selection between or to control the blending of the current image frame's features and the denoised preceding image frame's features. For example, if a scene is stationary, the features of the denoised preceding image frame 204 may be favored by the attention map. If the scene contains motion, the denoised preceding image frame 204 (although cleaner) typically does not match with the reality captured in the current image frame 202.

In particular embodiments, the attention map may be used as part of an alpha blending process in which (i) the aligned extracted features of the denoised preceding image frame 204 are each weighed by a weight in the attention map and (ii) the extracted features of the current image frame 202 are each weighed by an inverse of the weight in the attention map. The inverse of a weight could be defined in any suitable manner, such as by subtracting the weight from a value of one.

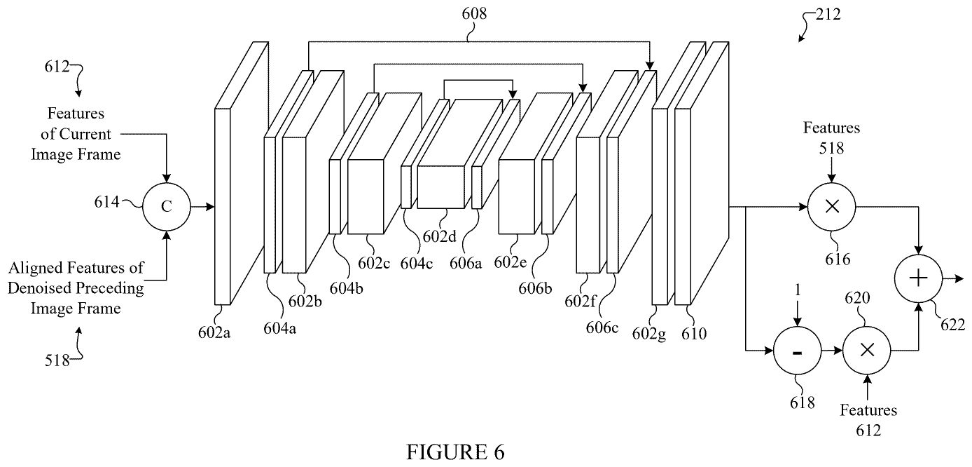

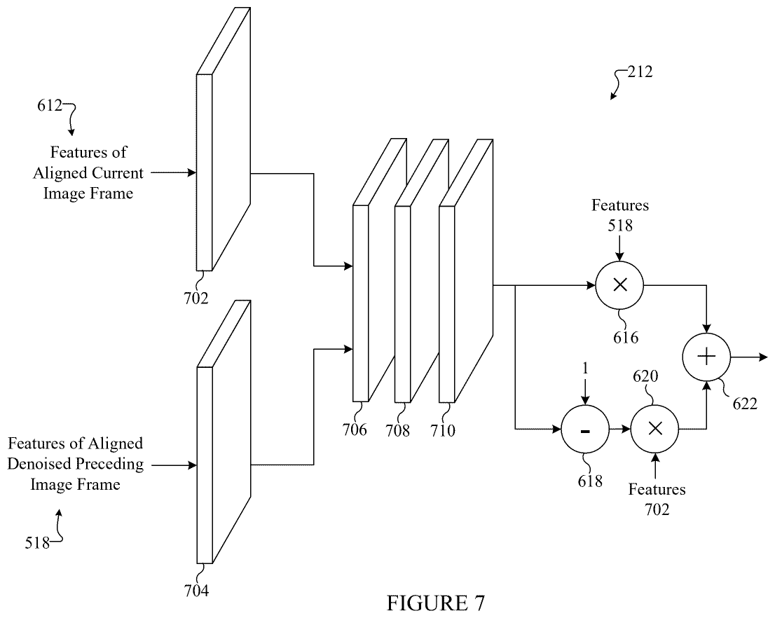

As can be seen here, the fusion operation 212 can perform adaptive fusion of the features since the weighted combination or other fusion can be adjusted based on the specific image frames 202, 204 being processed. Example embodiments of the fusion operation 212 are shown in FIG. 6 and in FIG. 7, which are described in more detail below. Note, however, that this disclosure is not limited to any particular technique(s) for performing feature fusion.

The fused features are provided to a decoding operation 214, which generally operates to perform decoding of the fused features in order to generate a denoised current image frame 216. The decoding operation 214 may represent a trained machine learning model or other logic that is configured to process fused features and generate image frames based on the fused features. In some embodiments, for example, the decoding operation 214 may be implemented using a single convolutional layer, which can be used to map the fused features from a latent feature space into pixel data in an image space. The decoding operation 214 may map the fused features into any suitable image space, such as when the decoding operation 214 maps the fused features into an RBG image frame, a YUV image frame, or other image frame. As a particular example, the decoding operation 214 may be implemented using a single convolutional layer having a three-by-three kernel size and a padding size of one, where the convolutional layer maps fused features in a 32-channel latent feature space or other feature space into a three-channel RGB image frame or other multi-channel image frame. Note, however, that this disclosure is not limited to any particular technique(s) for performing feature decoding.

The denoised current image frame 216 represents a cleaner version of the current image frame 202. Depending on the circumstances, the denoised current image frame 216 might still contain some amount of noise, but the noise is significantly reduced compared to the noise contained in the current image frame 202. This represents one iteration using the architecture 200 in which a current image frame 202 is processed and denoised. Additional iterations may occur any number of times, where each iteration involves obtaining a new current image frame 202 and processing the new current image frame 202 along with the most-recent denoised preceding image frame 204. The iterations may continue to occur until all of the image frames in a video sequence have been processed. Note that the first frame in a video sequence may lack a denoised preceding image frame. To initiate the denoising process, an initial denoised image frame 204 may be generated based on the first and second image frames in the video sequence, such as by treating the second image frame as the current image frame 202 and using the first image frame as the denoised preceding image frame 204 (even though the first image frame has not actually been denoised). At that point, the iterations described above may be performed for each subsequent image frame starting with the third image frame, where each subsequent image frame is denoised using the denoised preceding image frame. Note, however, that some other technique (such as a standard denoising technique) may be used to denoise the first image frame in the sequence and generate the first denoised image frame.

The architecture 200 can therefore support a recursive feedback mechanism in which a denoised image frame \hat{x}ₜ₋₁ from a previous time step t-1 can serve as an input that is used to generate a denoised image frame \hat{x}ₜ for the subsequent time step t (possibly with the exception of the initial denoising of the first two image frames). In some cases, the architecture 200 may only need to store and process two image frames at any given time, which can provide significant reductions in the amount of computational and memory resources required. In addition, by processing the image frames 202 in conjunction with the denoised preceding image frames 204 during the various iterations, this can help to ensure temporal coherence in a denoised video sequence that includes the denoised image frames 204. Among other things, this temporal coherence can reduce or eliminate the creation of flickering artifacts or other artifacts in the denoised video sequence.

The machine learning model(s) or other logic in the architecture 200 may be trained or otherwise configured in any suitable manner. In some embodiments, one, some, or all of the operations 206-214 in the architecture 200 may include or be associated with learnable parameters that are iteratively optimized in a data-driven manner. Any suitable training data may also be used to train or otherwise configure the architecture 200. In some embodiments, for example, the training data may include the MPI video denoising dataset, which provides noisy/clean video pairs generated via the MPI multi-frame noise reduction (MFNR) technique. In particular embodiments, the training or configuration process for the architecture 200 may occur in multiple stages, such as during a local-window pretraining stage and a recurrent training stage. During the local-window pretraining stage, two consecutive noisy image frames may be randomly sampled from the training dataset, and a loss can be calculated for the latter frame (and this can be repeated any suitable number of times and the losses can be aggregated or otherwise used to calculate an overall loss). In the recurrent training stage, six consecutive image frames (denoted x₀-x₅) or other number of image frames can be randomly sampled, and a first denoised image frame \hat{x}₁ may be obtained (such as by using the first two image frames x₀ and x₁). Subsequent denoised image frames \hat{x}ₜ (where t>1) can be generated using the previous denoised frame \hat{x}ₜ₋₁ and the current noisy frame xₜ, and the architecture 200 can be adjusted to reduce the differences (loss) between generated denoised image frames and ground truth image frames. In some cases, both training stages may employ the Adam optimizer, such as with a learning rate of 2×10⁻⁵. In some cases, to calculate the loss, an l₁ distance between the output of the architecture 200 and the corresponding ground truth may be calculated. Note, however, that the architecture 200 may be trained or otherwise configured in any other suitable manner.

Although FIG. 2 illustrates one example of an architecture 200 that supports machine learning-based video denoising with adaptive fusion, various changes may be made to FIG. 2. For example, various components or operations in FIG. 2 may be combined, further subdivided, replicated, rearranged, or omitted according to particular needs. Also, various additional components or functions may be used in FIG. 2.

FIGS. 3A and 3B illustrate an example feature extraction operation 206, 208 in the architecture 200 of FIG. 2 in accordance with this disclosure. As shown in FIG. 3A, each feature extraction operation 206, 208 may be implemented using a U-net architecture that includes residual blocks 302a-302g, strided convolutional layers 304a-304c, and transpose convolutional layers 306a-306c. Skip connections 308 may be used between residual blocks 302a-302g at common levels within the U-net architecture. Each of the residual blocks 302a-302g may be implemented using one or more residual denoiser blocks 310, which is shown in FIG. 3B. As shown in FIG. 3B, each residual denoiser block 310 may include two convolutional layers 312a-312b, a rectified linear unit (ReLU) layer 314, and a combination operation 316 that combines an input 318 to the convolutional layer 312a and an output from the convolutional layer 312b to generate an output 320 of the residual denoiser block 310. In some embodiments, each of the residual blocks 302a-302g may include multiple residual denoiser blocks 310 coupled in series, such as four cascaded residual denoiser blocks 310. The residual denoiser blocks 310 in the residual block 302a may be preceded by an initial convolutional layer that transforms an image frame 202 or 204 into a latent feature space representation, such as when the initial convolutional layer converts an RGB image frame having a format of 3×H×W (indicating three color channels each having a height H and a width W) into a 32×H×W latent feature space representation (indicating there are 32 channels in the latent feature space representation having the same height H and width W). Of course, the actual number of color channels and latent feature space channels may vary as needed or desired.

In some embodiments, each of the residual blocks 302a-302g may maintain the same number of channels and the same spatial dimensions (H and W), meaning the output of each residual block 302a-302g can have the same number of channels and the same spatial dimensions as its input. Each of the strided convolutional layers 304a-304c may double the number of channels and halve the spatial dimensions, and each of the transpose convolutional layers 306a-306c may halve the number of channels and double the spatial dimensions. In particular embodiments, each of the convolutional layers 312a-312b, strided convolutional layers 304a-304c, and transpose convolutional layers 306a-306c may have a three-by-three kernel size and a padding size of one. The skip connections 308 here allow residuals determined by one of the residual blocks 302a-302g to be provided directly to another of the residual blocks 302a-302g having the same number of channels and spatial dimensions without passing through one or more intervening ones of the residual blocks 302a-302g.

FIGS. 4A and 4B illustrate another example feature extraction operation 206, 208 in the architecture 200 of FIG. 2 in accordance with this disclosure. As shown in FIG. 4A, each feature extraction operation 206, 208 may be implemented using a convolutional layer 402 and a sequence of two or more residual blocks 404a-404n. The convolutional layer 402 can again represent an initial convolutional layer that transforms an image frame 202 or 204 into a latent feature space representation, such as when the convolutional layer 402 converts an RGB image frame having the format 3×H×W into a 32×H×W latent feature space representation. A skip connection 406 may be used between the convolutional layer 402 and a last of the residual blocks 404n. In some cases, this can allow the output of the convolutional layer 402 to be combined with the output of the last residual block 404n.

The two or more residual blocks 404a-404n represent cascaded residual blocks that can process the latent feature space representation of the image frame 202 or 204. In some embodiments, each of the residual blocks 404a-404n may be implemented using one or more residual denoiser blocks 410, which is shown in FIG. 4B. As shown in FIG. 4B, each residual denoiser block 410 may include two convolutional layers 412a-412b, a ReLU layer 414, and a combination operation 416 that combines an input 418 to the convolutional layer 412a and an output from the convolutional layer 412b to generate an output 420 of the residual denoiser block 410. The residual denoiser block 410 shown here may be the same as or similar to the residual denoiser block 310 described above. In the example of FIGS. 4A and 4B, the number of channels and the spatial dimensions may remain the same throughout the components of the feature extraction operation 206, 208.

Although FIGS. 3A through 4B illustrate examples of the feature extraction operation 206, 208 in the architecture 200 of FIG. 2, various changes may be made to FIGS. 3A through 4B. For example, various components or operations in each of FIGS. 3A through 4B may be combined, further subdivided, replicated, rearranged, or omitted according to particular needs. Also, various additional components or functions may be used in each of FIGS. 3A through 4B. In addition, other approaches for extracting features from image frames may be used in the architecture 200.

FIG. 5 illustrates an example alignment operation 210 in the architecture 200 of FIG. 2 in accordance with this disclosure. As shown in FIG. 5, the alignment operation 210 can receive the current image frame 202, the denoised preceding image frame 204, and determined features 502 of the denoised preceding image frame 204. The determined features 502 may, for instance, represent the features of the denoised preceding image frame 204 as generated by the feature extraction operation 208.

The current image frame 202 and the denoised preceding image frame 204 are processed using one or more filtering operations 504-506, which generally operate to filter the image data of the image frames 202, 204. Each filtering operation 504-506 can use any suitable technique(s) to filter image data. For example, in some embodiments, each filtering operation 504-506 may filter image data using a low-pass filtering technique, which in some cases may take the form of a convolution. As a particular example, each filtering operation 504-506 may filter image data by convolving the image data with a zero-mean unit-variance Gaussian kernel or other suitable kernel. Note, however, that this disclosure is not limited to any particular technique(s) for filtering image data. Also note that while multiple filtering operations 504-506 are shown here, this is merely for ease of illustration, and the same filtering operation may be used to process the image frames 202, 204.

The filtered image data for the current image frame 202 and the filtered image data for the denoised preceding image frame 204 are processed using one or more down-sampling operations 508-510, which generally operate to down-sample the filtered image data. For example, each down-sampling operation 508-510 can reduce the amount of filtered image data to be subsequently processed and provide lower-resolution image data. Each down-sampling operation 508-510 can down-sample the associated filtered image data by any suitable factor, such as when each down-sampling operation 508-510 can reduce the amount of filtered image data by a factor of four. Note, however, that this disclosure is not limited to any particular technique(s) for down-sampling image data. Also note that while multiple down-sampling operations 508-510 are shown here, this is merely for ease of illustration, and the same down-sampling operation may be used to process the filtered image data.

The down-sampled image data for the current image frame 202 and the down-sampled image data for the denoised preceding image frame 204 are provided to a flow estimation operation 512, which generally operates to estimate the optical flow between the image frames 202, 204. For example, the flow estimation operation 512 may identify the optical flow from the denoised preceding image frame 204 to the current image frame 202. The optical flow can be expressed in any suitable manner, such as by using one or more optical flow vectors that identify motion of image content in the denoised preceding image frame 204 to corresponding positions of the same image content in the current image frame 202. The flow estimation operation 512 can use any suitable technique(s) to identify optical flow between image frames. In some embodiments, the flow estimation operation 512 may use a Recurrent All-Pairs Field Transforms (RAFT) technique to identify optical flow. Note, however, that this disclosure is not limited to any particular technique(s) for identifying optical flow.

The identified optical flow is provided to an up-sampling operation 514, which generally operates to up-sample the optical flow and generate an up-sampled or higher-resolution optical flow. For example, the up-sampling operation 514 may up-sample the identified optical flow vector(s) using the same factor used by the down-sampling operation(s) 508-510. Thus, for instance, the up-sampling operation 514 may up-sample the identified optical flow vector(s) by a factor of four. The up-sampling operation 514 may use any suitable technique(s) to up-sample an optical flow, such as bilinear interpolation. Note, however, that this disclosure is not limited to any particular technique(s) for up-sampling optical flows.

A warping operation 516 receives the determined features 502 of the denoised preceding image frame 204 and the up-sampled optical flow. The warping operation 516 generally operates to warp the determined features 502 of the denoised preceding image frame 204 based on the up-sampled optical flow in order to generate aligned features 518 of the denoised preceding image frame 204. The aligned features 518 of the denoised preceding image frame 204 represent features of the denoised preceding image frame 204 that are more-closely aligned spatially with corresponding features of the current image frame 202 as determined by the feature extraction operation 206. As can be seen here, the warping operation 516 can operate in the latent feature space, such as where FE(\hat{x}ₜ₋₁) represents the determined features 502 for \hat{x}ₜ₋₁, which represents the denoised preceding image frame 204. The warping operation 516 can achieve spatial alignment of FE(\hat{x}ₜ₋₁) and FE(xₜ), which represents the determined features for xₜ (the current image frame 202). This facilitates the subsequent fusion/integration of relevant information from the denoised preceding image frame 204 and the current frame 202, helping to promote temporal consistency. The warping operation 516 may use any suitable technique(s) to warp features, such as bilinear interpolation. Note, however, that this disclosure is not limited to any particular technique(s) for warping features.

Although FIG. 5 illustrates one example of an alignment operation 210 in the architecture 200 of FIG. 2, various changes may be made to FIG. 5. For example, various components or operations in FIG. 5 may be combined, further subdivided, replicated, rearranged, or omitted according to particular needs. Also, various additional components or functions may be used in FIG. 5. In addition, other approaches for aligning features from image frames may be used in the architecture 200.

FIG. 6 illustrates an example fusion operation 212 in the architecture 200 of FIG. 2 in accordance with this disclosure. As shown in FIG. 6, part of the fusion operation 212 may have the same or similar structure as the feature extraction operation 206 of FIG. 3A. For example, the fusion operation 212 may be implemented using a U-net architecture that includes residual blocks 602a-602g, strided convolutional layers 604a-604c, and transpose convolutional layers 606a-606c. Skip connections 608 may be used between residual blocks 602a-602g at common levels within the U-net architecture. The U-net architecture here additionally includes an activation layer 610, such as a sigmoid activation layer.

The residual blocks 602a-602g in the fusion operation 212 may have the same or similar form as the residual blocks 302a-302g in the feature extraction operation 206 described above. For example, each residual block 602a-602g may include one or more residual denoiser blocks 310 (like four cascaded residual denoiser blocks 310). However, unlike the U-net architecture in FIG. 3A, the number of channels may remain constant across each scale within the U-net architecture in FIG. 6, except for the final convolutional layer in the residual block 602g that can map multiple channels (such as 64 channels) to a single channel before sigmoid activation.

As shown in FIG. 6, features 612 of the current image frame 202 (which may be generated by the feature extraction operation 206) and the aligned features 518 of the denoised preceding image frame 204 are provided to a combination function 614, which can combine the features 612, 518 for input to the U-net architecture. For example, the combination function 614 may concatenate the features 612 of the current image frame 202 and the aligned features 518 of the denoised preceding image frame 204. The U-net architecture here processes the features 612, 518 and generates an attention map, which may identify how to fuse or otherwise combine the features 612, 518. For instance, the attention map may include weights that define how at least some of the features 612, 518 should be weighted to fuse the features 612, 518 in a pixel-wise manner. In some embodiments, the attention map has dimensions of 1×H×W and is used to pixel-wise fuse the features \hat{x}ₜ₋₁ of the denoised preceding image frame 204 and the features xₜ of the current image frame 202.

The attention map can be used to fuse the features 612, 518 in any suitable manner. In this particular example, the features 612, 518 are fused using an alpha blending process in which features for one image frame are weighted by first weights (α) from the attention map and the corresponding features for the other image frame are weighted by second weights (1-α). Here, this is achieved using a multiplication function 616, a subtraction function 618, a multiplication function 620, and a combination function 622. The multiplication function 616 performs an element-wise multiplication of the aligned features 518 of the denoised preceding image frame 204 by corresponding weights in the attention map. The subtraction function 618 subtracts each weight in the attention map from a value of one to generate new weights (inverse weights), and the multiplication function 620 performs an element-wise multiplication of the features 612 of the current image frame 202 by corresponding new weights. The combination function 622 adds or otherwise combines the weighted values generated by the multiplication functions 616, 620 to produce weighted or fused features.

FIG. 7 illustrates another example fusion operation 212 in the architecture 200 of FIG. 2 in accordance with this disclosure. As shown in FIG. 7, the features 612 of the current image frame 202 and the aligned features 518 of the denoised preceding image frame 204 are respectively provided to convolutional layers 702 and 704. The convolutional layers 702 and 704 embed the features 612, 518 in a first latent feature space. Note that while multiple convolutional layers 702-704 are shown here, this is merely for ease of illustration, and the same convolutional layer may be used to process the features 612, 518.

The resulting embeddings of the features 612, 518 are provided to a pixel-wise correlation layer 706, which identifies pixel-wise correlations between the aligned features as embedded in the first latent feature space to generate a correlation map. The correlation map can identify, on a pixel-wise basis, the strengths of the correlations between the pixels of the embeddings of the features 612, 518. A convolutional layer 708 processes the correlation map from the pixel-wise correlation layer 706 in order to embed the correlation map in a second latent feature space, and an activation layer 710 applies a sigmoid activation or other activation function to the correlation map as embedded in the second latent feature space. This leads to the generation of an attention map, which again identifies how to fuse the features 612, 518. The subsequent operations 616-622 described above may again be used to perform an alpha blending process of the features 612, 518 based on the attention map.

Although FIGS. 6 and 7 illustrate examples of the fusion operation 212 in the architecture 200 of FIG. 2, various changes may be made to FIGS. 6 and 7. For example, various components or operations in each of FIGS. 6 and 7 may be combined, further subdivided, replicated, rearranged, or omitted according to particular needs. Also, various additional components or functions may be used in each of FIGS. 6 and 7. In addition, other approaches for fusing features extracted from image frames may be used in the architecture 200, such as other approaches that do not rely on alpha blending.

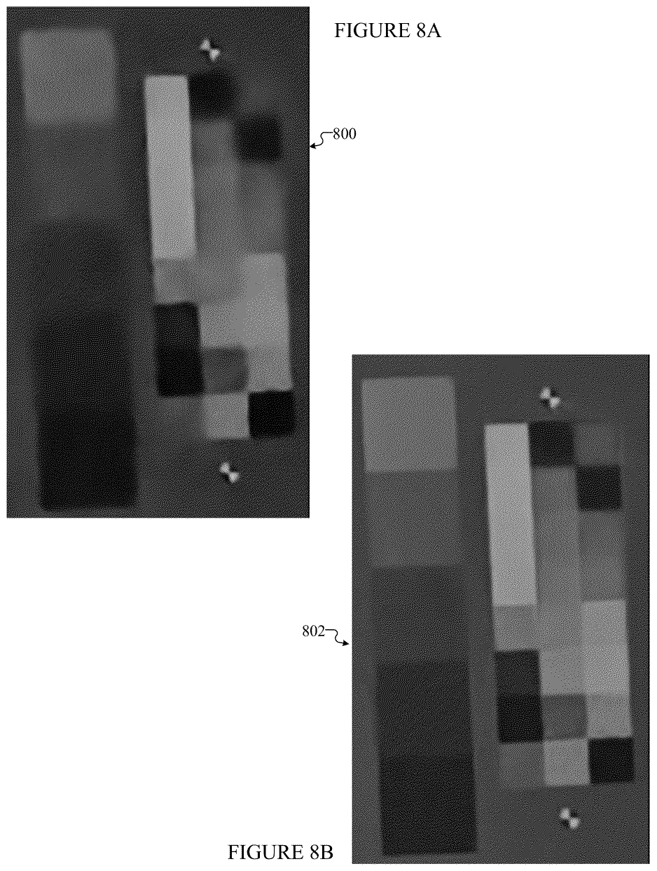

FIGS. 8A and 8B illustrate example results obtainable using machine learning-based video denoising with adaptive fusion in accordance with this disclosure. More specifically, FIG. 8A illustrates part of an example output image 800 that could be generated without machine learning-based video denoising. As can be seen here, the image 800 includes portions that are somewhat blurry without sharp edges. If a sequence of images 800 is generated in this manner, the resulting video sequence may suffer from flickering or other artifacts and generally be of lower picture quality.

In contrast, FIG. 8B illustrates part of an example output image 802 that could be generated using the architecture 200, which supports machine learning-based video denoising with adaptive fusion. As can be seen here, the image 802 is much clearer compared to the image 800. Moreover, if a sequence of images 802 is generated using the architecture 200, the resulting video sequence may suffer from significantly less or no flickering or other artifacts and generally be of higher picture quality. This may be achieved (among other reason) by the ability to denoise image frames in a sequence using denoised versions of preceding image frames in the sequence.

Although FIGS. 8A and 8B illustrate one example of results obtainable using machine learning-based video denoising with adaptive fusion, various changes may be made to FIGS. 8A and 8B. For example, FIGS. 8A and 8B are merely meant to illustrate one example of a type of benefit that might be obtained using the techniques of this disclosure. The specific results that are obtained in any given situation can vary based on the circumstances and based on the specific implementation of the techniques described in this disclosure.

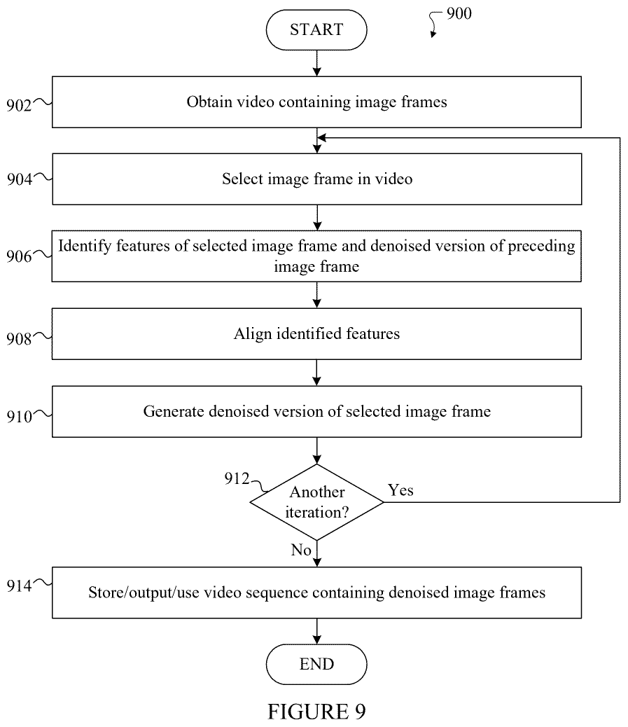

FIG. 9 illustrates an example method 900 for machine learning-based video denoising with adaptive fusion in accordance with this disclosure. For ease of explanation, the method 900 shown in FIG. 9 is described as being performed by the electronic device 101 in the network configuration 100 of FIG. 1, where the electronic device 101 can implement the architecture 200 shown in FIG. 2. However, the method 900 shown in FIG. 9 could be performed by any other suitable device(s) and architecture(s) and in any other suitable system(s), such as when the method 900 is performed using the server 106.

As shown in FIG. 9, a video containing image frames is obtained at step 902. This may include, for example, the processor 120 of the electronic device 101 generating or otherwise obtaining multiple image frames of a scene using one or more imaging sensors 180. The video can include a sequence of any suitable number of image frames spanning any suitable length of time. If needed or desired, this may also include pre-processing the image frames in any suitable manner.

An image frame in the video is selected at step 904, and features of the selected image frame and a denoised version of the preceding image frame are identified at step 906. This may include, for example, the processor 120 of the electronic device 101 selecting the most-recently captured image frame 202 in the video or otherwise selecting a current image frame 202 for processing. This may also include the processor 120 of the electronic device 101 performing the feature extraction operation(s) 206-208 to identify the features 612 of the current image frame 202 and the features 502 of the denoised preceding image frame 204. As noted above, during the processing of the first two image frames in the video, the second image frame may be selected as the current image frame 202, and the first image frame may be treated as the denoised version of the preceding image frame 204 (even though the first image frame may not actually be denoised). The identified features are aligned at step 908. This may include, for example, the processor 120 of the electronic device 101 performing the alignment operation 210 to align the features 502 of the denoised preceding image frame 204 with the features 612 of the current image frame 202, thereby generating aligned features 518 of the denoised preceding image frame 204. A denoised version of the selected image frame is generated at step 910. This may include, for example, the processor 120 of the electronic device 101 performing the fusion operation 212 in order to combine the features 612 of the current image frame 202 and the aligned features 518 of the denoised preceding image frame 204. This may also include the processor 120 of the electronic device 101 performing the decoding operation 214 to decode the fused features and generate a denoised current image frame 216.

A determination is made whether to perform another iteration of the denoising process at step 912. This may include, for example, the processor 120 of the electronic device 101 determining whether any additional image frames in the video need to be denoised. If so, the process returns to step 904, at which point the processor 120 of the electronic device 101 may select the next image frame in the video as a new current image frame 202 and use the denoised current image frame 216 as the denoised preceding image frame 204. Otherwise, a video sequence containing the denoised image frames may be stored, output, or used in some manner at step 914. For example, the video sequence containing the denoised image frames may be displayed on the display 160 of the electronic device 101, saved to a camera roll stored in a memory 130 of the electronic device 101, or attached to a text message, email, or other communication to be transmitted from the electronic device 101. Of course, the video sequence containing the denoised image frames could be used in any other or additional manner.

Although FIG. 9 illustrates one example of a method 900 for machine learning-based video denoising with adaptive fusion, various changes may be made to FIG. 9. For example, while shown as a series of steps, various steps in FIG. 9 may overlap, occur in parallel, occur in a different order, or occur any number of times (including zero times). As a particular example, the method 900 may include any suitable number of iterations in order to denoise any suitable number of image frame in a video.

It should be noted that the functions described above can be implemented in an electronic device 101, 102, 104, server 106, or other device(s) in any suitable manner. For example, in some embodiments, at least some of the functions can be implemented or supported using one or more software applications or other software instructions that are executed by the processor 120 of the electronic device 101, 102, 104, server 106, or other device(s). In other embodiments, at least some of the functions can be implemented or supported using dedicated hardware components. In general, the functions described above can be performed using any suitable hardware or any suitable combination of hardware and software/firmware instructions. Also, the functions described above can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. A method comprising:
obtaining, using at least one processing device of an electronic device, a video comprising a sequence of image frames; and
during each of multiple iterations:
identifying, using the at least one processing device, features of a specified image frame in the sequence and features of a denoised version of a preceding image frame;
aligning, using the at least one processing device, the features of the specified image frame in the sequence and the features of the denoised version of the preceding image frame to generate aligned features; and
generating, using the at least one processing device, a denoised version of the specified image frame based on the aligned features.

2. The method of claim 1, further comprising:
generating an initial denoised image frame based on first and second image frames in the sequence;
wherein the iterations are performed to denoise subsequent image frames in the sequence after the first and second image frames, wherein each subsequent image frame is denoised using the denoised version of the preceding image frame.

3. The method of claim 1, wherein, during each iteration, aligning the features of the specified image frame in the sequence and the features of the denoised version of the preceding image frame comprises:
down-sampling filtered versions of the specified image frame and the preceding image frame to generate down-sampled image frames;
performing optical flow estimation based on the down-sampled image frames to generate an optical flow;
up-sampling the optical flow to generate an up-sampled optical flow; and
warping at least some of the features based on the up-sampled optical flow.

4. The method of claim 1, wherein, during each iteration, generating the denoised version of the specified image frame comprises:
performing a fusion of the aligned features to generate fused features; and
performing decoding of the fused features to generate the denoised version of the specified image frame.

5. The method of claim 4, wherein, during each iteration, performing the fusion of the aligned features comprises:
generating an attention map based on the aligned features using a trained machine learning model, the attention map identifying how to fuse the aligned features; and
performing a weighted combination of the features of the denoised version of the preceding image frame as aligned with the features of the specified image frame in the sequence.

6. The method of claim 4, wherein, during each iteration, performing the fusion of the aligned features comprises:
embedding the aligned features in a first feature space using single-layer convolution;
identifying pixel-wise correlations between the aligned features as embedded in the first feature space to generate a correlation map;
embedding the correlation map in a second feature space;
applying an activation function to the correlation map as embedded in the second feature space to generate an attention map, the attention map identifying how to fuse the aligned features; and
performing a weighted combination of the features of the denoised version of the preceding image frame as aligned with the features of the specified image frame in the sequence.

7. The method of claim 1, wherein processing the specified image frames in conjunction with the denoised versions of the preceding image frames during the iterations ensures temporal coherence in a denoised video sequence comprising the denoised versions of the image frames, thereby avoiding flickering in the denoised video sequence.

8. An apparatus comprising:
at least one processing device configured to:
obtain a video comprising a sequence of image frames; and
during each of multiple iterations:
identify features of a specified image frame in the sequence and features of a denoised version of a preceding image frame;
align the features of the specified image frame in the sequence and the features of the denoised version of the preceding image frame to generate aligned features; and
generate a denoised version of the specified image frame based on the aligned features.

9. The apparatus of claim 8, wherein:
the at least one processing device is further configured to generate an initial denoised image frame based on first and second image frames in the sequence;
the at least one processing device is configured to perform the iterations to denoise subsequent image frames in the sequence after the first and second image frames, wherein each subsequent image frame is denoised using the denoised version of the preceding image frame.

10. The apparatus of claim 8, wherein, to align the features of the specified image frame in the sequence and the features of the denoised version of the preceding image frame during each iteration, the at least one processing device is configured to:
down-sample filtered versions of the specified image frame and the preceding image frame to generate down-sampled image frames;
perform optical flow estimation based on the down-sampled image frames to generate an optical flow;
up-sample the optical flow to generate an up-sampled optical flow; and
warp at least some of the features based on the up-sampled optical flow.

11. The apparatus of claim 8, wherein, to generate the denoised version of the specified image frame during each iteration, the at least one processing device is configured to:
perform a fusion of the aligned features to generate fused features; and
perform decoding of the fused features to generate the denoised version of the specified image frame.

12. The apparatus of claim 11, wherein, to perform the fusion of the aligned features during each iteration, the at least one processing device is configured to:
generate an attention map based on the aligned features using a trained machine learning model, the attention map identifying how to fuse the aligned features; and
perform a weighted combination of the features of the denoised version of the preceding image frame as aligned with the features of the specified image frame in the sequence.

13. The apparatus of claim 11, wherein, to perform the fusion of the aligned features during each iteration, the at least one processing device is configured to:
embed the aligned features in a first feature space using single-layer convolution;
identify pixel-wise correlations between the aligned features as embedded in the first feature space to generate a correlation map;
embed the correlation map in a second feature space;
apply an activation function to the correlation map as embedded in the second feature space to generate an attention map, the attention map identifying how to fuse the aligned features; and
perform a weighted combination of the features of the denoised version of the preceding image frame as aligned with the features of the specified image frame in the sequence.

14. The apparatus of claim 8, wherein the at least one processing device is configured to process the specified image frames in conjunction with the denoised versions of the preceding image frames during the iterations to ensure temporal coherence in a denoised video sequence comprising the denoised versions of the image frames, thereby avoiding flickering in the denoised video sequence.

15. A non-transitory machine-readable medium containing instructions that when executed cause at least one processor to:
obtain a video comprising a sequence of image frames; and
during each of multiple iterations:
identify features of a specified image frame in the sequence and features of a denoised version of a preceding image frame;
align the features of the specified image frame in the sequence and the features of the denoised version of the preceding image frame to generate aligned features; and
generate a denoised version of the specified image frame based on the aligned features.

16. The non-transitory machine-readable medium of claim 15, further containing instructions that when executed cause the at least one processor to generate an initial denoised image frame based on first and second image frames in the sequence;
wherein the instructions when executed cause the at least one processor to perform the iterations to denoise subsequent image frames in the sequence after the first and second image frames, wherein each subsequent image frame is denoised using the denoised version of the preceding image frame.

17. The non-transitory machine-readable medium of claim 15, wherein the instructions that when executed cause the at least one processor to align the features of the specified image frame in the sequence and the features of the denoised version of the preceding image frame during each iteration comprise:
instructions that when executed cause the at least one processor to:
down-sample filtered versions of the specified image frame and the preceding image frame to generate down-sampled image frames;
perform optical flow estimation based on the down-sampled image frames to generate an optical flow;
up-sample the optical flow to generate an up-sampled optical flow; and
warp at least some of the features based on the up-sampled optical flow.

18. The non-transitory machine-readable medium of claim 15, wherein the instructions that when executed cause the at least one processor to generate the denoised version of the specified image frame during each iteration comprise:
instructions that when executed cause the at least one processor to:
perform a fusion of the aligned features to generate fused features; and
perform decoding of the fused features to generate the denoised version of the specified image frame.

19. The non-transitory machine-readable medium of claim 18, wherein the instructions that when executed cause the at least one processor to perform the fusion of the aligned features during each iteration comprise:
instructions that when executed cause the at least one processor to:
generate an attention map based on the aligned features using a trained machine learning model, the attention map identifying how to fuse the aligned features; and
perform a weighted combination of the features of the denoised version of the preceding image frame as aligned with the features of the specified image frame in the sequence.

20. The non-transitory machine-readable medium of claim 18, wherein the instructions that when executed cause the at least one processor to perform the fusion of the aligned features during each iteration comprise:
instructions that when executed cause the at least one processor to:
embed the aligned features in a first feature space using single-layer convolution;
identify pixel-wise correlations between the aligned features as embedded in the first feature space to generate a correlation map;
embed the correlation map in a second feature space;
apply an activation function to the correlation map as embedded in the second feature space to generate an attention map, the attention map identifying how to fuse the aligned features; and
perform a weighted combination of the features of the denoised version of the preceding image frame as aligned with the features of the specified image frame in the sequence.
